(19) United States
(12) Patent Application Publication
(10) Pub. No.: US 2007/0125684 A1
(43) Pub. Date: Jun. 7, 2007

(54) Hydrocracking Catalyst and Process

(76) Inventors: Martijn Hendrik Biesmans, Amsterdam (NL); Johannes Anthonius Robert Van Veen, Amsterdam (NL); Ingrid Maria Van Vegchel, Amsterdam (NL)

Correspondence Address: SHELL OIL COMPANY, P O BOX 2463, HOUSTON, TX, 772522463, US

(21) Appl. No.: 11/532,085

(22) Filed: Sep. 14, 2006

(30) Foreign Application Priority Data
Sep. 14, 2005 (EP) 05255622.2

(51) Int. Cl. C10G 47/24; C10G 47/02; B01J 29/04; B01J 29/06; B01J 21/00; B01J 29/08

(52) U.S. Cl. 208/108; 502/60; 502/63; 502/64; 502/74; 502/79

(57) ABSTRACT

The invention provides a hydrocracking catalyst which comprises (i) a carrier which comprises an amorphous silica-alumina and a zeolite, (ii) a Group VIII metal, (iii) a Group VIB metal, and (iv) boron as the sole promoter element, a process for its preparation and the use thereof, particularly in single stage hydrocracking.

The present invention relates to, a hydrocracking catalyst, a process of preparing a hydrocracking catalyst, and a hydrocracking process.

### BACKGROUND OF THE INVENTION

Processes that comprise treating crude oil and other petroleum feedstocks with hydrogen in the presence of a catalyst are well known. One such process is hydrocracking, in which heavy distillate hydrocarbons are converted under hydrogen pressure into products of lower molecular weight in the presence of a catalyst. Hydrocracking is used in the oil industry to prepare a wide range of materials, ranging from C3/C4 production to luboil manufacture.

Hydrocracking may be operated as either a single or two-stage process. Two-stage hydrocracking involves a first stage, which is predominantly a hydrotreatment stage wherein impurities and unsaturated compounds are hydrogenated in the presence of a first catalyst having a high hydrogenation function, and a second-stage where most of the cracking occurs in the presence of a second catalyst having a strong cracking function. In single-stage hydrocracking, the treatment and cracking steps occur in one reactor and may be performed using a single catalyst. The catalysts employed in hydrocracking are generally made from a carrier material on which there are deposited catalytically active metals such as nickel, molybdenum, tungsten, palladium etc.

The higher the activity of a hydrocracking catalyst the more efficient a conversion will be. In particular, a more active catalyst can be operated at a lower temperature than a less active catalyst to achieve the same degree of conversion. This is advantageous as a lower operating temperature prolongs catalyst life and decreases operating costs. Accordingly, there is always a need for improving catalyst activity.

Promoters to enhance the performance of catalysts based on amorphous carrier materials are known and described in the art. Thus silicon promotion is disclosed for amorphous catalyst compositions for a variety of uses in WO 95/11753, U.S. Pat. No. 5,507,940, EP-A-533451 and EP-A-586196. Other promoters have also been proposed for use in amorphous-based hydrocracking catalysts: in US-A-2002/0160911 and U.S. Pat. No. 6,251,261 the use of boron and phosphorus as promoters is disclosed in addition to silicon as a promoter.

Promotion has also been proposed for zeolitic-based hydrocracking catalysts. In U.S. Pat. No. 6,667,267, U.S. Pat. No. 6,712,953 and U.S. Pat. No. 6,531,051, promotion of a zeolitic catalyst using at least one of silicon phosphorus and boron is proposed. The additional use of fluorine to enhance catalytic performance is also disclosed. However in each catalyst that shows a demonstrable difference in properties over a non-promoted comparison catalyst, always a combination of promoters is used. Thus in Table 9 of U.S. Pat. No. 6,667,267 a significant improvement in catalyst activity is shown but only where two or more promoters are present; for Mo/IM-5 and MoB/IM-5 no activity difference is noted. The same table demonstrates that neither boron nor silicon promotion provides an increase in activity for the comparison zeolite Y catalysts. All the catalysts of Table 9 contain supports of zeolitic material in combination with an alumina matrix or binder. Two silica-alumina bound zeolitic catalysts are tested (Table 8), both having phosphorus promotion, but even with phosphorus co-promotion, no significant catalytic activity improvement is found with the addition of boron.

We have found that the increase in catalyst activity that has been disclosed or suggested in the prior art by treating catalyst with a liquid silicon-containing compound, the most frequently suggested promoter in the prior art, is not achieved when a mixed amorphous silica-alumina and zeolitic supported catalyst is used. Indeed we have found that the presence of an aluminosilicate zeolite material in an amorphous silica-alumina carrier is deleterious when a silicon promoter is used.

It has now surprisingly been found that although silicon promotion significantly reduces the activity of such mixed amorphous and zeolitic based hydrocracking catalyst, boron promotion in contrast provides a significant increase in catalytic activity without the need for any additional promoter elements and with an unchanged selectivity and hydrogenation performance.

Accordingly the present invention provides a hydrocracking catalyst which comprises (i) a carrier which comprises an amorphous silica-alumina and a zeolite, (ii) a Group VIII metal, (iii) a Group VIB metal, and (iv) boron as the sole promoter element.

It is believed that the effect may be seen with any combination of aluminosilicate zeolite and amorphous silica-alumina. Thus the zeolite may be any zeolite proposed for use in a hydrocracking catalyst. However good results have been found with the use of a faujasite zeolite, particularly a zeolite Y. The zeolite Y is usefully a stabilised zeolite Y having a unit cell size in the range of from 24.10 to 24.40 Å and a bulk or overall silica to alumina ratio (SAR) in the range of from 4 to 100. Preferably the zeolite Y has a SAR in the range of from 50 to 100, especially from 70 to 90. Such zeolite Y materials are readily available commercially such as, for example, from Zeolyst International.

More than one zeolite may be present in the catalyst, and such additional zeolite may be any suitable zeolite found to exhibit a useful hydrocracking activity, especially when used in a small quantity in a hydrocracking catalyst. Suitable additional zeolite can be selected from zeolite beta, zeolite ZSM-5, and a zeolite Y of a different unit cell size and/or SAR than primarily used in the catalyst of the invention.

The amount of total zeolite in the catalyst of the invention is usefully in the range of from 1 to 10% wt based on total carrier and preferably in the range of from 1 to 5, especially 1 to 3, % wt.

The catalyst of the invention may contain in the range of from 0.1 to 20% wt, preferably 0.1 to 15% wt, and more preferably 0.1 to 10% wt of boron, based on the amount of total carrier. Most especially an amount in the range of from 0.5 to 5, especially to 2% wt boron is present.

The boron may be incorporated into the catalyst at any stage in the manufacture of the catalyst. Thus it may be incorporated into the silica-alumina; it may be added to the carrier components during mixing and prior to shaping; or it may be added after shaping directly to the shaped carrier prior to metals impregnation. Mechanisms for boron addition at any of these stages are known to the skilled person.

It is preferred that the boron is incorporated into the catalyst by treating the shaped carrier with a boron source or by combining the boron source with the carrier materials prior to mixing and shaping.

The boron source may be boric acid, preferably orthoboric acid H₃BO₃, ammonium biborate or ammonium pentaborate, boron oxide, or boric esters. Boron can be introduced, for example, in the form of a mixture of boric acid, oxidized water and a basic organic compound that contains nitrogen, such as ammonia, primary and secondary amines, cyclic amines, the compounds of the pyridine family and quinolines, and the compounds of the pyrrole family. Boron may also be introduced by, for example, a solution of boric acid in water or in a water/alcohol mixture.

The catalyst of the present invention employs an amorphous silica-alumina material in the carrier. The term “amorphous” indicates a lack of crystal structure, as defined by X-ray diffraction, in the carrier material, although some short range ordering may be present. Amorphous silica-alumina suitable for use in preparing the catalyst carrier is available commercially. Alternatively, the silica-alumina may be prepared by a co-gelation process or a grafting process, as are well known in the art. The amorphous silica-alumina preferably contains silica in an amount in the range of from 25 to 95% by weight as calculated on the carrier alone (i.e. based on total carrier). More preferably the amount of silica in the carrier is greater than 35% wt, and most preferably at least 40% wt. A very suitable amorphous silica-alumina product for use in preparing the catalyst carrier comprises 45% by weight silica and 55% by weight alumina and is commercially available (ex. Criterion Catalysts and Technologies, USA).

The boron component is the sole promoter of the catalyst of the invention. Thus, no additional phosphorus, fluorine or silicon is utilised in the catalyst, however, of course silicon will be present as part of the amorphous silica-alumina component. Silicon promotion is conventionally by use of an additional liquid silicon-containing compound such as alkyl orthosilicates, e.g. ethyl orthosilicate siloxanes and silicone oils; no such compound is utilised in the catalyst of the present invention.

The mixed amorphous silica-alumina/zeolite carrier of the present invention may be prepared by any of the suitable carrier preparation techniques known in the art. A preferred method for the preparation of the carrier comprises mulling a mixture of the amorphous silica-alumina, the zeolite and a suitable liquid, extruding the mixture and drying and heating the resulting extrudates, at a temperature in the range of from 400 to 1000° C., as for example described in WO-9410263. As noted above, the suitable liquid may be, or contain, the boron source.

The extrudates may have any suitable form known in the art, for example cylindrical, hollow cylindrical, multilobed or twisted multilobed. A preferred shape for the catalyst particles is multilobed, for example trilobed. Typically, the extrudates have a nominal diameter of from 0.5 to 5 mm, preferably from 1 to 3 mm. After extrusion, the extrudates are dried. Drying may be performed at an elevated temperature, preferably up to 300° C., more preferably up to 200° C.. The period for drying is typically up to 5 hours, preferably in the range of from 30 minutes to 3 hours. Preferably, the extrudates are then further heated (calcined) after drying at very high temperature, preferably between 400 and 1000° C., typically for a period of up to 5 hours, preferably in the range of from 30 minutes to 4 hours.

The hydrocracking catalyst employed in the process of the present invention comprises a Group VIII metal and a Group VIB metal, as classified according to CAS notation as given in the Periodic Table published in the CRC Handbook of Chemistry and Physics, 68^{th} Edition, 1985, CRC Press, INC.

Preferably, the Group VIII metal is selected from nickel, cobalt, or mixtures thereof; whilst the Group VIB metal is preferably selected from molybdenum and tungsten or mixtures thereof. In a preferred embodiment of the invention, the Group VIII metal is nickel and the Group VIB metal is molybdenum and/or tungsten, preferably tungsten.

The amount of Group VIII metal and Group VIB metal in the catalyst may vary depending on the metal type and the intended purpose of the catalyst, however, the amount of Group VIII metal will preferably be in the range of from 0.5 to 10% wt, whilst the amount of Group VIB metal will preferably be in the range of from 3 to 30% wt, measured as the metal, based on total weight of catalyst. A preferred catalyst according to the present invention, comprises nickel in an amount in the range of from 1 to 6% wt, more preferably 3 to 6% wt; and molybdenum in an amount in the range of from 6 to 18% wt, preferably 10 to 15% wt, or tungsten in an amount in the range of from 10 to 25% wt, preferably 15 to 22% wt.

The Group VIII and Group VIB metals may be deposited on the carrier using any of the suitable methods known in the art, for example by ion exchange, competitive ion exchange or impregnation. Conveniently, the metals may be deposited by impregnating the carrier with an impregnation solution comprising appropriate metal-containing compounds, and optionally a chelating agent such as ethylene glycols, ethylene diamine, citric acid, malic acid, nitriloacetic acid or ethylenediaminetetraacetic acid (EDTA). After impregnation, the catalyst is preferably dried at a temperature of up to 200° C., then heated at a temperature in the range of from 200 to 1000° C., for example to 500° C.

The total surface area of the catalyst is preferably greater than 100 m²/g and more preferably in the range of from 200 to 300 m²/g, as determined by the B.E.T. method. The total pore volume is preferably greater than 0.4 ml/g. The upper pore volume will be determined by the minimum surface area required. Preferably in the range of from 5 to 40 volume percent of the total pore volume is present as pores having a diameter of more than 350 Å. References to the total pore volume are to the pore volume determined using the Standard Test Method for Determining Pore Volume Distribution of Catalysts by Mercury Intrusion Porosimetry, ASTM D 4284-88.

In the process of the present invention, the hydrocracking catalysts are preferably sulphided prior to use. The catalyst may conveniently be sulphided by any of the techniques known in the art, such a ex-situ or in-situ sulphidation. For example, sulphidation may be performed by contacting the catalyst with a sulphur-containing gas, such as a mixture of hydrogen and hydrogen sulphide, a mixture of hydrogen and carbon disulphide or a mixture of hydrogen and a mercaptan, such as butylmercaptan. Alternatively, sulphidation may be carried out by contacting the catalyst with hydrogen and a sulphur-containing hydrocarbon oil, such as sulphur-containing kerosene or gas oil. The sulphur may also be introduced into the hydrocarbon oil by the addition of a suitable sulphur-containing compound, for example dimethyldisulphide or tert-nonylpolysulphide.

The hydrocracking process of the present invention comprises hydrocracking a feedstock in the presence of hydrogen and a hydrocracking catalyst. As will be understood by those skilled in the art, the conditions employed for the hydrocracking process may vary, however, in general the temperature of the conversion is preferably in the range of from 250 to 500° C., more preferably 300 to 450° C., and most preferably 350 to 450° C. Moreover, the total pressure in the hydrocracking process will preferably be in the range of from 5×10⁶ Pa (50 bar) to 3×10⁷ Pa (300 bar), more preferably 7.5×10⁶ Pa (75 bar) to 2.5×10⁷ Pa (250 bar) and even more preferably 1×10⁷ Pa (100 bar) to 2×10⁷ Pa (200 bar); whilst hydrogen partial pressure will preferably be in the range of from 2.5×10⁶ Pa (25 bar) to 2.5×10⁷ Pa (250 bar), more preferably 5×10⁶ Pa (50 bar) to 2×10⁷ Pa (200 bar) and still more preferably 6×10⁶ Pa (60 bar) to 1.8×10⁷ Pa (180 bar). Furthermore, the space velocity of the feedstock in terms of kg fresh feedstock per litre catalyst per hour (kg·l⁻¹·h⁻¹) will preferably be in the range of from 0.1 to 10, more preferably 0.2 to 8, and even more preferably 0.5 to 5; whilst total gas rates (gas/feed ratios) will preferably in the range of from 100 to 5000 Nl/kg, more preferably 250 to 2500 Nl/kg.

A wide range of feedstocks may be used in the process of the present invention. Examples of feedstocks that may conveniently be employed include gas oils, coker gas oils, vacuum gas oils, deasphalted oils, fractions (e.g. gas oil and wax fractions) prepared using a Fischer-Tropsch synthesis process, long residues, catalytically cracked cycle oils, thermally or catalytically cracked gas oils, and syncrudes, optionally originating from tar sands, shale oils, residue upgrading processes or biomass. Combinations of various hydrocarbon oils may also be employed. The feedstock will generally be such that at least 50% wt has a boiling point above 370° C. It is an advantageous aspect of the present invention that nitrogen or sulphur contents in the hydrocarbonaceous feedstock are not critical, and the feedstock may have a nitrogen content of up to 5000 ppmw (parts per million by weight) and a sulphur content of up to 6% wt. Typically, nitrogen contents may be in the range of from 250 to 2000 ppmw and sulphur contents are in the range of from 0.2 to 5% wt.

The hydrocracking process of the present invention may be used to particularly advantageous effect in single-stage hydrocracking, wherein it gives a good efficiency of conversion even on exposure to feedstocks comprising nitrogen and sulphur-containing contaminants.

One application of single-stage hydrocracking is the production of middle distillate fractions. Middle distillate fractions are liquid fractions having a boiling point in the range of from 150 to 370° C., and include products such as kerosene (150 to 250° C.) and gas oil (250 to 370° C.). There is a growing demand for middle distillate products, and as such there is always a need for hydrocracking processes that show a strong selectivity for middle distillates with minimum formation of gaseous (C₁-C₄) material, i.e. processes whose products contain low amounts of gaseous material and high amounts of middle distillate. In this regard, the hydrocracking process of the present invention has proven to be extremely selective at converting heavy distillate feedstocks, such as heavy gas oils or deasphalted oils to middle distillate fractions.

Accordingly, a preferred embodiment of the present invention provides for the single-stage conversion of a heavy gas oil or a deasphalted oil to a middle distillate fraction.

The invention will be further understood from the following illustrative examples.

### EXAMPLES

The following standard catalyst preparation was used in these Examples.

A commercial amorphous silica-alumina, ASA (Al—Si:55-45% wt, available from Criterion Catalysts and Technologies, USA) was mix-mulled with a stabilised Y zeolite in the ratio 98% wt ASA to 2% wt zeolite in the presence of sufficient water to produce an extrudable dough. The Y zeolite used had a silica to alumina molar ratio of 80 and a unit cell size of 24.24 and is available from Zeolyst International under the designation CBV 780. The mixture was then mixed with an extrusion aid (Superfloc) and extruded into extrudates having in cross section a trilobe shape and being 1.3 mm in length. The extrudates were statically dried and calcined. Following this, metals were emplaced and the impregnated extrudates were dried and calcined by conventional procedures.

### Example 1—Comparative

In this Example a zeolite-amorphous silica-alumina catalyst prepared as above, was tested in single stage hydrocracking both with and without applied silicon promotion. Shown in Table 1 are the details of the metals and silicon promoter content of this catalyst (Catalyst A), and of a catalyst prepared by treating zeolite-containing Catalyst A with polydimethylsiloxane (obtainable from Bayer under the designation M-50) as a solution in n-heptane (1.1 g siloxane/10 g catalyst), and then heating at a temperature of 150° C. (Catalyst B).

TABLE 1

Comparative Catalysts

| | A | B |
|---|---|---|
| Ni (% wt)¹ | 5 | 5 |
| W (% wt)¹ | 21 | 21 |
| Si (% wt)² | 0 | 4 |

¹As determined by elemental analysis, based on total weight of catalyst before treatment with polydimethylsiloxane.
²As determined by elemental analysis, based on total weight of catalyst after treatment with polydimethylsiloxane.

The catalysts were tested for their hydrocracking activity in a single-stage hydrocracking simulation test using a heavy gas oil feedstock having the properties shown in Table 2.

TABLE 2

| Feedstock Properties | | |
|---|---|---|
| Carbon content | 85.03% | wt |
| Hydrogen content | 11.86% | wt |
| Sulphur content | 3.00% | wt |
| Nitrogen content | 980 | ppmw |
| Density (15/4° C.) | 0.9327 | g/ml |
| Density (70/4° C.) | 0.8966 | g/ml |
| Ramsbottom carbon | 0.62% | wt |
| Aromatics content | 18% | wt |
| Initial boiling point | 305° | C. |
| 50% w boiling point | 463° | C. |
| Final boiling point | ˜650° | C. |
| Fraction boiling below 370° C. | 7.7% | wt |
| Fraction boiling above 540° C. | 17.6% | wt |

The testing was carried out in once-through microflow equipment loaded with a single catalyst bed comprising 10 ml of catalyst diluted with an equal volume of either 0.05 mm or 0.1 mm silicon-carbide particles. Prior to the testing, the catalyst was presulfided using a mixture of hydrogen and hydrogen disulphide at a pressure of 15 bar (1.5 MPa), and with a temperature profile rising from ambient (22° C.) to a final temperature of 375° C.

To measure hydrocracking activity, the heavy gas oil feedstock was contacted with catalyst in a once-through operation at a space velocity of 0.75 kg heavy gas oil per litre catalyst per hour [kg/l/l]; a hydrogen gas/heavy gas oil ratio of 1500 Nl/kg; and a total pressure of 140 bar (14 MPa). Hydrocracking performance was assessed in terms of the temperature required to convert 65% wt of feedstock components having a boiling point of 370° C. or above to material boiling at less than 370° C.: catalysts with higher activities requiring lower temperatures. The results are shown in Table 3, together with overall product selectivities.

From Table 3 it can be seen that the silicon treated zeolite-containing catalyst (Catalyst B) has a significantly lower activity than that of the corresponding untreated catalyst (Catalyst A).

TABLE 3

Catalyst:

| | A | B |
|---|---|---|
| Temp, required for 65% w conv., (° C.) | 402 | 408 |
| Product selectivities, % w of product | 4.5 | 4 |
| Gas (C₁-C₄) | | |
| Naphtha (C₅-150° C.) | 22 | 21 |
| Kerosine (150-250° C.) | 32.5 | 33 |
| Gas Oil (250-370° C.) | 41 | 42 |

### Example 2

Further catalysts were prepared corresponding to Catalyst A of Example 1, but with the addition of boron in various ways and in various amounts, which were then tested alongside a non-boron-containing catalyst in a single-stage hydrocracking simulation test as described in Example 1, utilising the same conditions and test feed.

Catalyst 1

The standard catalyst preparation was followed but subsequent to calcination of the statically dried extrudates, and prior to metals impregnation, boric acid was added by conventional procedures such that an amount equivalent to the pore volume of the carrier was incorporated (pore volume impregnation). The amount of boron added to the carrier by this method is shown in Table 4.

Catalyst 2

The preparation method of Catalyst 1 was followed except that the boric acid was added in the mix-mulling stage.

Catalyst 3

The preparation method of Catalyst 1 was followed except that the pore volume impregnation with boric acid was modified to ensure that 2% wt boron was added to the carrier.

Catalyst C

The preparation method of Catalyst 1 was followed except that no boron was added to the carrier.

All four catalysts were then tested in a single stage hydrocracking test as per Example 1. The activity results are given in Table 5; the product selectivities and hydrogenation activity of each catalyst showed insignificant variations and are not quoted here.

It can be seen from Table 5 that the presence of boron has improved the activity by 3° C.

TABLE 4

Catalyst

| | 1 | 2 | 3 | C |
|---|---|---|---|---|
| Ni (% wt) | 5 | 5 | 5 | 5 |
| W (% wt) | 21 | 21 | 21 | 21 |
| B (% wt) | 1.2 | 1.2 | 2 | 0 |

TABLE 5

Catalyst

| | 1 | 2 | 3 | C |
|---|---|---|---|---|
| Temp. Required for | 401 | 401 | 401 | 404 |
| 65% wt conversion | | | | |
| (° C.) | | | | |

We claim:

1. A hydrocracking catalyst which comprises (i) a carrier which comprises an amorphous silica-alumina and a zeolite, (ii) a Group VIII metal, (iii) a Group VIB metal, and (iv) boron as the sole promoter element.

2. A hydrocracking catalyst as claimed in claim 1, wherein the carrier contains in the range of from 1 to 10% wt of zeolite.

3. A hydrocracking catalyst as claimed in claim 2, wherein the zeolite is a zeolite Y having an overall silica to alumina molar ratio in the range of from 50 to 100.

4. A hydrocracking catalyst as claimed in claim 3, wherein the catalyst contains in the range of from 0.1 to 20% wt boron, based on the amount of carrier.

5. A hydrocracking catalyst as claimed in claim 4, wherein the Group VIII metal is nickel and the Group VIB metal is molybdenum and/or tungsten.

6. A hydrocracking catalyst as claimed in claim 5, wherein the amorphous silica-alumina contains at least 40% wt of silica.

7. A process for the preparation of a hydrocracking catalyst as claimed in claim 1, which comprises treating the carrier, and/or the constituent materials of the carrier, with a boron source, and subsequently impregnating the carrier with a Group VIII metal and a Group VIB metal.

8. A process as claimed in claim 7, wherein the boron-source is, or contains, boric acid.

9. A hydrocracking process which comprises contacting a hydrocarbonaceous feedstock in the presence of hydrogen with a hydrocracking catalyst as claimed in claim 1.
